(19) United States
(12) Patent Application Publication
(10) Pub. No.: US 2013/0044169 A1
(43) Pub. Date: Feb. 21, 2013

(54) IMAGE FORMING APPARATUS AND IMAGE FORMING METHOD

(71) Applicant: Yuhei CHIWATA, Kanagawa (JP)

(72) Inventor: Yuhei CHIWATA, Kanagawa (JP)

(73) Assignee: FUJIFILM CORPORATION, Tokyo (JP)

(21) Appl. No.: 13/558,367

(22) Filed: Jul. 26, 2012

(30) Foreign Application Priority Data
Aug. 19, 2011 (JP) 2011-179954

(51) Int. Cl. B41J 2/01

(52) U.S. Cl. 347/102

(57) ABSTRACT

An image forming apparatus includes: an image forming member; a conveying member that retains with a retaining member a leading end portion of the recording medium and conveys the recording medium; a suction-attachment plate that is disposed with a separation to the conveying member, the suction-attachment plate suction-attaching the back face of the recording medium being conveyed by the conveying member while the leading end portion of the recording medium is retained by the retaining member and including a suction-attachment face at a temperature of from 30° C. to 70° C. for suction-attaching the recording medium; and a heating member that is disposed on the opposite side of the conveyed recording medium to the suction-attachment plate side and heats and dries the recording medium such that the front face of the recording medium being conveyed by the conveying member is imparted with heat energy of from 1.0 J/cm² to 5.0 J/cm².

### CROSS-REFERENCE TO RELATED APPLICATION

This application claims priority under 35 USC 119 from Japanese Patent Application No. 2011-179954 filed on Aug. 19, 2011, the disclosure of which is incorporated by reference herein.

### BACKGROUND

1. Technical Field

The present invention relates to an image forming apparatus and an image forming method for forming an image on a recording medium.

2. Related Art

Technology is described in Japanese Patent Application Laid-Open (JP-A) No. 08-224871 in which recording paper (recording medium) on which characters have been formed is heated by radiation heat irradiated from an infrared heater (heating member) and by hot air that can be heated by an infrared heater, so as to fix the characters onto the recording paper.

However, the heat energy to be supplied to the recording medium by the heating member is not specified in the conventional configuration, and sometimes sufficient heating energy is not supplied to the recording medium, and the film strength of images formed on the recording medium is not secured.

### SUMMARY

The present invention provides an image forming apparatus and an image forming method that secures quality of film strength of an image formed on a recording medium across from the leading end side to the trailing end side of the recording medium.

An image forming apparatus of a first aspect of the present invention includes: an image forming member that jets liquid droplets onto a recording medium and forms an image on a front face of the recording medium; a conveying member that retains with a retaining member a leading end portion of the recording medium on which the image has been formed by the image forming member and conveys the recording medium; a suction-attachment plate that is disposed with a separation from the conveying member, the suction-attachment plate suction-attaching a back face of the recording medium being conveyed by the conveying member while the leading end portion of the recording medium is retained by the retaining member and including a suction-attachment plate with a temperature at a suction-attachment surface of from 30° C. to 70° C. for suction-attaching the recording medium; and a heating member that is disposed on an opposite side of the conveyed recording medium to the suction-attachment plate side and heats and dries the recording medium such that the front face of the recording medium being conveyed by the conveying member is imparted with heat energy of from 1.0 J/cm² to 5.0 J/cm².

According to the above configuration, the suction-attachment plate with the suction-attachment surface at a temperature of from 30° C. to 70° C. suction-attaches the back face of the recording medium being conveyed by the conveying member while the leading end portion of the recording medium is retained by the retaining member. The heating member also heats and dries the recording medium such that the front face of the recording medium being conveyed by the conveying member while suction-attached to the suction-attachment plate is imparted with heat energy of from 1.0 J/cm² to 5.0 J/cm².

The quality of film strength of an image formed on the recording medium can accordingly be secured across from the leading end side to the trailing end side of the recording medium.

An image forming apparatus of a second aspect of the present invention is the first aspect of the present invention further including a cooling member for cooling the suction-attachment plate provided at an opposite side of the suction-attachment plate to the conveying member side.

According to the above configuration, the temperature of the suction-attachment surface can also be easily regulated due to the cooling member cooling the suction-attachment surface.

An image forming apparatus of a third aspect of the present invention is the first aspect of the present invention further including a heater for heating the suction-attachment plate installed in the suction-attachment plate.

According to the above configuration, the temperature of the suction-attachment surface can be easily regulated due to the heater heating the suction-attachment plate.

An image forming apparatus of a fourth aspect of the present invention is the first aspect of the present invention further including: a measuring member for measuring the temperature of the suction-attachment surface of the suction-attachment plate; a cooling member for cooling the suction-attachment plate; a heater for heating the suction-attachment plate; and a controller that controls the cooling member and/or the heater based on the measurement result of the measuring member such that the temperature of the suction-attachment surface is from 30° C. to 70° C.

According to the above configuration, the temperature of the suction-attachment surface can be even more easily regulated due to the controller controlling the cooling member and/or the heater based on the measurement results of the temperature sensor.

An image forming apparatus of a fifth aspect of the present invention is the first aspect of the present invention wherein: the image forming member jets ultraviolet-curing ink towards the recording medium; and the image forming apparatus further includes an ultraviolet lamp that illuminates light for curing ultraviolet-curing ink onto the recording medium heated and dried by the heating member.

According to the above configuration, the film strength of images can be efficiently enhanced due to using the ultraviolet lamp to illuminate light towards an image formed with ultraviolet curing ink.

An image forming apparatus of a sixth aspect of the present invention is the first aspect of the present invention wherein the image forming member jets ink containing thermoplastic resin particles towards the recording medium.

According to the above configuration, the quality of film strength of images can be enhanced without employing ultraviolet curing inks due to the image forming method jetting ink containing thermoplastic resin particles towards the recording medium.

An image forming apparatus of a seventh aspect of the present invention is the first aspect of the present invention further including an air moving member that blows air against the front face of the recording medium being conveyed by the conveying member.

According to the above configuration, heating and drying of the recording medium by the heater can be promoted by the air moving member blowing air against the front face of the recording medium being conveyed by the conveying member.

An image forming apparatus of an eighth aspect of the present invention is the first aspect of the present invention further including a process liquid application member that is provided at a recording medium conveying direction upstream side of the image forming member and that applies to the recording medium a process liquid for enhancing adhesiveness of liquid droplets to the recording medium.

According to the above configuration, the process liquid application member applies the recording medium with the process liquid for enhancing the adhesiveness of the liquid droplets to the recording medium. The adhesiveness of the liquid droplets (ink) to the recording medium can accordingly be enhanced.

An image forming apparatus of a ninth aspect of the present invention is the eighth aspect of the present invention further including a drying member that dries the process liquid that has been applied to the recording medium by the process liquid application member.

According to the above configuration, the drying member dries the process liquid applied to the recording medium by the process liquid application member. Adhesiveness of the liquid droplets (ink) to the recording medium can accordingly be further enhanced.

An image forming method of a tenth aspect of the present invention includes: an image forming process of jetting liquid droplets onto a recording medium and forming an image on a front face of the recording medium; and a heating and drying process of making a temperature of a suction-attachment surface for suction-attaching a back face of the recording medium that is being conveyed while a leading end portion of the recording medium is retained be from 30° C. to 70° C., and heating and drying the recording medium such that the front face of the recording medium being conveyed is imparted with heat energy of from 1.0 J/cm² to 5.0 J/cm².

According to the above configuration, in the heating and drying process the temperature of the suction-attachment surface, for suction-attaching the back face of the recording medium that is being conveyed while the leading end portion of the recording medium is retained, is made from 30° C. to 70° C., and the recording medium is heated and dried such that the front face of the conveyed recording medium is imparted with heat energy of from 1.0 J/cm² to 5.0 J/cm². The quality of film strength of an image formed on the recording medium can accordingly be secured across from the leading end side to the trailing end side of the recording medium.

An image forming method of an eleventh aspect of the present invention is the tenth aspect of the present invention, wherein: the liquid droplets for forming an image on the recording medium are liquid droplets of ultraviolet-curing ink; and the image forming method further includes a light illumination process of illuminating light for curing ultraviolet-curing ink towards the recording medium whose image has been heated and dried in the heating and drying process.

According to the above configuration, the film strength of images can be enhanced due to light for curing ultraviolet-curing ink being illuminated in the light illumination process towards the recording medium whose image has been heated and dried in the heating and drying process.

An image forming method of a twelfth aspect of the present invention is the tenth aspect of the present invention further including, prior to the image forming process, a process liquid application process in which a process liquid is applied to the recording medium for enhancing adhesiveness to the recording medium of the liquid droplets jetted towards the recording medium in the image forming process.

According to the above configuration, the adhesiveness of the liquid droplets (ink) to the recording medium can be enhanced due to, in the process liquid application process, applying to the recording medium the process liquid for enhancing adhesiveness to the recording medium of the liquid droplets jetted towards the recording medium in the image forming process.

An image forming method of a thirteenth aspect of the present invention is the twelfth aspect of the present invention further including a process liquid drying process in which the process liquid applied to the recording medium in the process liquid application process is dried.

According to the above configuration, the adhesiveness of the liquid droplets (ink) to the recording medium can be enhanced due to, in the process liquid drying process, drying the process liquid that was applied in the process liquid application process.

### BRIEF DESCRIPTION OF THE DRAWINGS

Exemplary embodiments of the present invention will be described in detail based on the following figures, wherein:

FIG. 1 is a configuration diagram illustrating an ink drying section applied to an image forming apparatus according to an exemplary embodiment of the present invention;

FIG. 2 is an enlarged configuration diagram illustrating an ink drying section applied to an image forming apparatus according to an exemplary embodiment of the present invention;

FIG. 3 is a perspective view illustrating a portion of an ink drying section applied to an image forming apparatus according to an exemplary embodiment of the present invention;

FIG. 4 is a block diagram illustrating control flow in a controller applied to an image forming apparatus according to an exemplary embodiment of the present invention;

FIG. 5 is a schematic configuration diagram illustrating an image forming apparatus according to an exemplary embodiment of the present invention;

FIG. 6 is a diagram illustrating the profile of a sheet member and an image pattern employed for evaluating an image forming apparatus according to an exemplary embodiment of the present invention;

FIG. 7A is a table illustrating evaluation results of evaluations of film strength of an image formed on a sheet member employing an image forming apparatus according to an exemplary embodiment of the present invention;

FIG. 7B is a table illustrating evaluation results of evaluations of film strength of an image formed on a sheet member employing an image forming apparatus according to an exemplary embodiment of the present invention;

FIG. 8A is a table illustrating evaluation results of evaluations of glossiness difference of an image formed on a sheet member employing an image forming apparatus according to an exemplary embodiment of the present invention;

FIG. 8B is a table illustrating evaluation results of evaluations of paper creasing for an image formed on a sheet member employing an image forming apparatus according to an exemplary embodiment of the present invention;

FIG. 9 is a table illustrating each evaluation result of images formed on a sheet member employing an image forming apparatus according to an exemplary embodiment of the present invention;

FIG. 10 is a table illustrating evaluation results of evaluations of glossiness difference of an image formed on a sheet member when a process liquid has been applied employing an image forming apparatus according to an exemplary embodiment of the present invention;

FIG. 11A is a table illustrating evaluation results of evaluations of film strength of an image formed on a sheet member when a process liquid has been applied and dried employing an image forming apparatus according to an exemplary embodiment of the present invention; and

FIG. 11B is a table illustrating evaluation results of evaluations of film strength of an image formed on a sheet member when a process liquid has been applied and dried employing an image forming apparatus according to an exemplary embodiment of the present invention.

### DETAILED DESCRIPTION

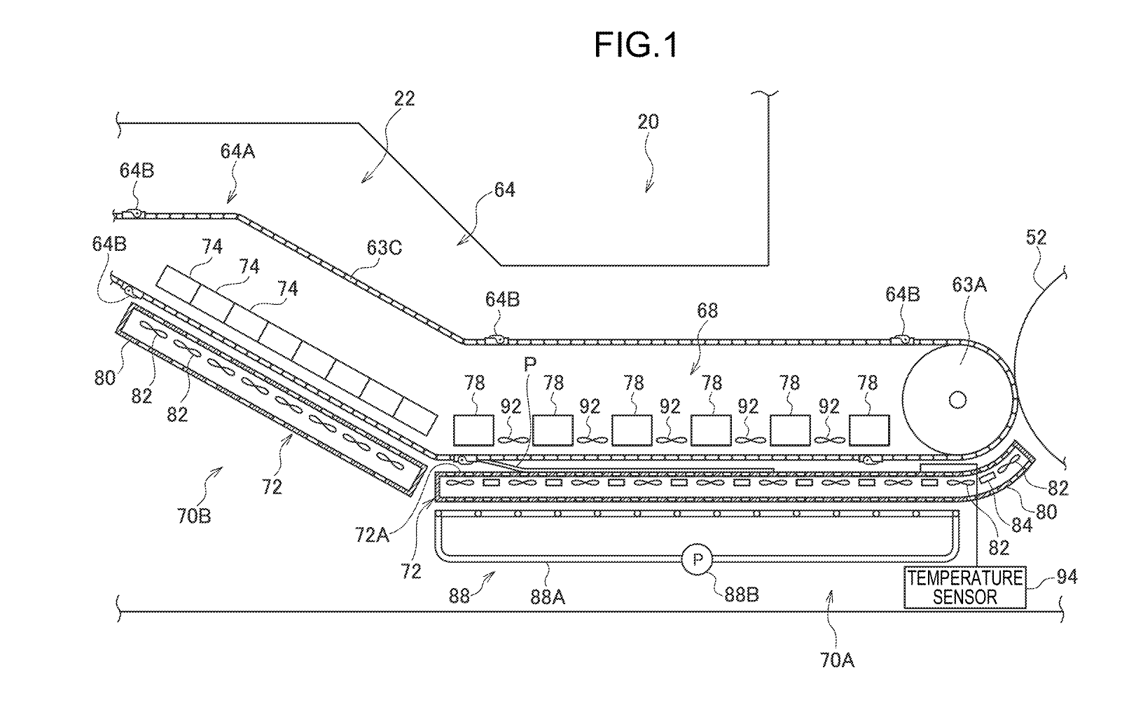

Explanation follows regarding an example of an image forming apparatus 10 according to an exemplary embodiment of the present invention, with reference to FIG. 1 to FIG. 11B. In the drawings the arrow UP indicates the vertically upwards direction.

Overall Configuration

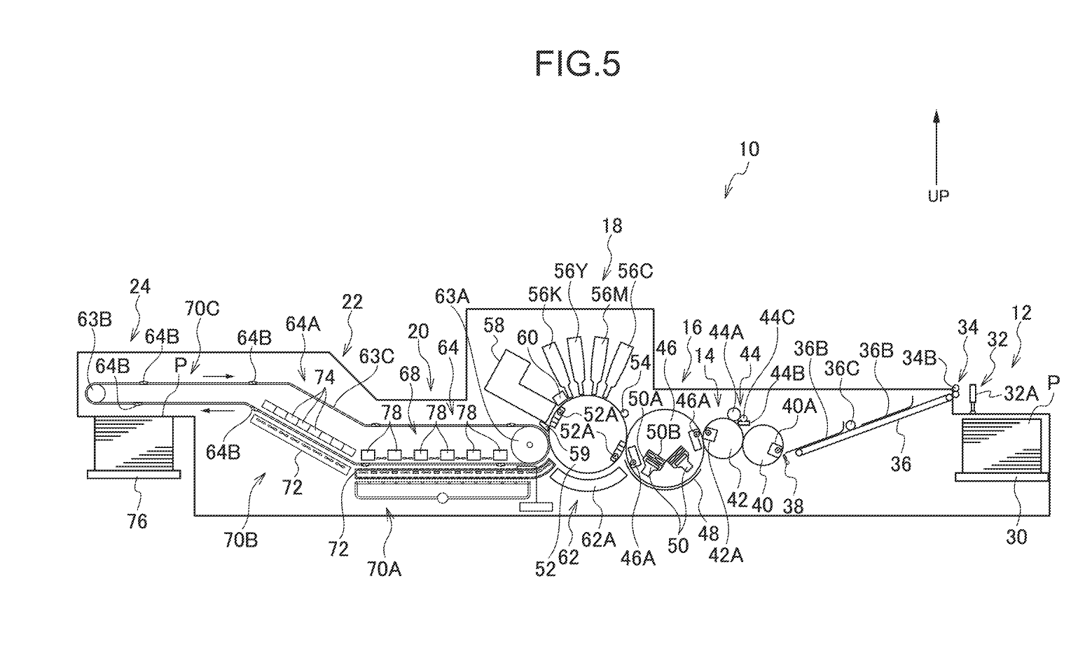

As shown in FIG. 5, the image forming apparatus 10 according to the present exemplary embodiment is an apparatus for forming an image on a sheet member P serving as a recording medium by an inkjet method using water-based UV inks (inks that use an aqueous medium and are cured with ultraviolet (UV) radiation). The image forming apparatus 10 is configured so as to mainly include: a paper feeder 12 for feeding each of the sheet members P; a process liquid application section 14 for applying a specific process liquid onto the front face (image recording face) of the sheet member P fed in from the paper feeder 12; a process liquid drying section 16 for drying the sheet member P to which the process liquid has been applied by the process liquid application section 14; an image recording section 18 for forming an image on the front face of the sheet member P that has been subjected to drying by the process liquid drying section 16; an ink drying section 20 for drying the sheet member P formed with an image by the image recording section 18; a UV irradiation section 22 for performing UV irradiation (fixing processing) to the sheet member P dried by the ink drying section 20 so as to fix the image onto the sheet member P; and a paper discharge section 24 for discharging the sheet members P that have been irradiated with UV by the UV irradiation section 22.

Paper Feeder

The paper feeder 12 is configured so as to mainly include: a paper feed plate 30 on which the sheet members P are stacked; a sucker device 32 that feeds out each of the sheet members P; paper feed rollers 34 that convey the fed sheet member P; a conveyor belt 36 that conveys the sheet member P; a front stop 38 that aligns the leading end portion of the sheet member P; and a paper feed drum 40 that conveys the sheet member P while rotating.

The paper feed plate 30 is equipped with a paper feed plate raising and lowering device (not shown in the drawings) for raising and lowering the paper feed plate 30 such that the uppermost sheet member P stacked on the paper feed plate 30 is at a constant height.

The sucker device 32 is equipped with suction feet 32A provided so as to be capable of raising, lowering and swinging. The top face of the sheet member P is suction-attached and retained by the suction feet 32A, such that the sheet member P is thereby fed out from the paper feed plate 30 to the paper feed rollers 34.

Specifically the suction feet 32A suction-attach and retain the top face of the leading edge side of the uppermost sheet member P stacked on the paper feed plate 30, pick up the sheet member P, and feed the leading edge of the picked-up sheet member P out towards the paper feed rollers 34.

The conveyor belt 36 is disposed so as to slope downwards on progression along the sheet member conveying direction towards the downstream side (referred to below simply as the conveying direction downstream side). The sheet member P mounted on the conveying face of the conveyor belt 36 is then guided along the conveying face to front stops 38.

Plural individual plate shaped retainers 36B are fixed above the conveying face of the conveyor belt 36 to suppress lifting up and undulations in the sheet member P being conveyed by the conveyor belt 36. The retainers 36B are disposed along the sheet member P conveying direction alongside each other in the sheet member P width direction (a direction orthogonal to the conveying direction along which the sheet member P is conveyed).

A roller 36C for pressing the conveyed sheet member P onto the conveying face of the conveyor belt 36 is provided between one of the retainers 36B and another of the retainers 36B aligned along the sheet member P conveying direction.

Plural individual of the front stops 38 are provided along the sheet member P width direction (referred to below simply as the sheet member width direction). The front stops 38 are provided such that leading edge portions of the sheet member P make contact with (are pressed against) the front stops 38 disposed in a row along the sheet member width direction, thereby correcting the orientation (skew) of the sheet member P.

The front stops 38 are also provided with pivoting devices (not shown in the drawings) to pivot the front stops 38 so as to pass the skew-corrected sheet member P across to the rotating paper feed drum 40.

The paper feed drum 40 is formed in a circular cylindrical shape and is provided with a drive source (not shown in the drawings) for rotating the paper feed drum 40. Grippers 40A are also provided on the outer peripheral face of the paper feed drum 40 for retaining leading edge portions of the conveyed sheet member P.

The thus configured paper feed drum 40 thereby conveys each of the sheet members P towards the process liquid application section 14 by rotating with the leading edge portions of the sheet member P retained by the grippers 40A and the sheet member P wrapped onto the peripheral face of the paper feed drum 40.

Process Liquid Application Section

The process liquid application section 14 is configured so as to mainly include: a process liquid application drum 42 for conveying the sheet member P, and a process liquid application unit 44, serving as an example of a process liquid application member, for applying to the front face of the sheet member P being conveyed by the process liquid application drum 42 a process liquid for enhancing adhesiveness of liquid droplets to the recording medium.

The process liquid application drum 42 is formed in a circular cylindrical shape and is provided with a drive source (not shown in the drawings) for rotating the process liquid application drum 42. Grippers 42A are also provided on the outer peripheral face of the process liquid application drum 42 for retaining the leading edge portions of the conveyed sheet member P.

The thus configured process liquid application drum 42 thereby conveys each of the sheet members P towards the process liquid drying section 16 by rotating, with the leading edge portions of the sheet member P that has been passed across from the paper feed drum 40 retained by the grippers 42A and with the sheet member P wrapped around the peripheral face of the process liquid application drum 42.

The process liquid application unit 44 is configured so as to mainly include: an application roller 44A for applying process liquid to the sheet member P; a process liquid tank 44B in which process liquid is stored; and a pickup roller 44C for picking up process liquid stored in the process liquid tank 44B and feeding it to the application roller 44A. The thus configured process liquid application unit 44 thereby applies the process liquid by roller to the front face of the sheet member P being conveyed by the process liquid application drum 42.

The process liquid contains an aggregating agent for aggregating components in ink compositions.

The aggregating agent may be a compound capable of changing the pH of ink compositions, may be a multivalent metal salt, or may be a polyallylamine compound. A compound capable of changing the pH of ink compositions is preferably employed in the present exemplary embodiment from the perspective of ability to aggregate ink compositions, and a compound that lowers the pH of ink compositions is more preferably employed. Examples of compounds suitably employed as a compound that lowers the pH of ink compositions is a highly water soluble acidic substance (such as phosphoric acid, oxalic acid, malonic acid, citric acid, or derivatives or salts of such compounds).

Thus a highly water soluble acidic substance is preferable as the aggregating agent, and an organic acid is preferable from the perspectives of raising the aggregating ability and solidifying the ink as a whole, and an organic acid of divalent or higher-valent is more preferable. An acidic substance of divalent or trivalent is particularly preferable. An organic acid with a first pKa of 3.5 or less is preferably among such organic acids of divalent or higher-valent, with an organic acid with first pKa of 3.0 or less being more preferable. Specific preferable examples thereof include phosphoric acid, oxalic acid, malonic acid and citric acid.

A single type of acidic substance alone may be employed as the aggregating agent, or two or more types may be employed in combination as the aggregating agent. The aggregating ability can thereby be raised and the ink can be solidified as a whole. The amount of aggregating agent contained in the process liquid for aggregating ink compositions is preferably set in the range of 1 to 50 percent by weight, more preferably in the range of 3 to 45 percent by weight, and even more preferably in the range of 5 to 40 percent by weight. The pH (25° C.) of ink compositions is preferably 8.0 or higher, and the pH (25° C.) of the process liquid is preferably in the range of 0.5 to 4. Image density and resolution can thereby be achieved together with a fast speed of inkjet recording.

The process liquid may contain other additives. Examples of known additives that may be employed therefor include drying inhibitors (wetting agents), anti-fading agents, emulsification stabilizers, penetration promoters, ultraviolet absorbers, preservatives, fungicides, pH adjusting agents, surface tension adjusting agents, anti-foaming agents, viscosity adjusting agents, dispersants, dispersion stabilizers, anti-rust agents and chelating agents.

Process Liquid Drying Section

The process liquid drying section 16 is configured so as to mainly include: a process liquid drying drum 46 for conveying the sheet member P; a conveying guide 48 that curves around the outer peripheral face of the process liquid drying drum 46; and process liquid drying units 50 serving as examples of drying members for drying the process liquid by blowing hot air against the front face of the sheet member P being conveyed by the process liquid drying drum 46.

The process liquid drying drum 46 is formed in a circular cylindrical shape and is provided with a drive source (not shown in the drawings) for rotating the process liquid drying drum 46. Grippers 46A are also provided on the outer peripheral face of the process liquid drying drum 46 for retaining leading edge portions of the conveyed sheet member P.

The thus configured process liquid drying drum 46 thereby conveys each of the sheet members P towards the image recording section 18 by rotating, with leading edge portions of the sheet member P that has been passed across from the process liquid application drum 42 retained by the grippers 46A and with the sheet member P wrapped around the peripheral face of the process liquid drying drum 46.

There are two of the individual process liquid drying units 50 provided inside the process liquid drying drum 46, each internally equipped with a heater 50A, and a fan 50B for blowing air that has been warmed by the heater 50A against the front face of the sheet member P.

Image Recording Section

The image recording section 18 is configured so as to mainly include: an image recording drum 52 for conveying each of the sheet members P; a press roller 54 for pressing the sheet member P conveyed by the image recording drum 52 so as to place the sheet member P in close contact with the peripheral face of the image recording drum 52; recording heads 56C, 56M, 56Y, 56K serving as examples of an image recording member for jetting liquid droplets (ink droplets) of colors C, M, Y, K, respectively, onto the sheet member P; an inline sensor 58 for reading image data formed on the sheet member P; a mist filter 60 for trapping ink mist; and a drum cooling unit 62 for cooling the image recording drum 52. The suffixes Y, M, C, K are omitted in the following explanation when there is no need to discriminate between Y, M, C, K.

The image recording drum 52 is formed in a circular cylindrical shape and is provided with a drive source (not shown in the drawings) for rotating the image recording drum 52. Grippers 52A are also provided on the outer peripheral face of the image recording drum 52 for retaining leading edge portions of the conveyed sheet member P.

The thus configured image recording drum 52 thereby conveys each of the sheet members P towards the ink drying section 20 by rotating, with the leading edge portions of the sheet member P that has been passed across from the process liquid drying drum 46 retained by the grippers 52A and the sheet member P wrapped around the peripheral face of the image recording drum 52.

The image recording drum 52 and the process liquid drying drum 46 of the present exemplary embodiment are disposed with the grippers 52A (46A) at 2 locations on the outer peripheral face, in a configuration capable of conveying two sheets of the sheet member P with a single rotation.

A multitude of suction holes (not shown in the drawings) are formed in the peripheral face of the image recording drum 52. The sheet member P wrapped around the peripheral face of the image recording drum 52 is accordingly conveyed while retained suction-attached to the peripheral face of the image recording drum 52 due to suction through the suction holes.

The press roller 54 is disposed in the vicinity of the sheet member receiving position of the image recording drum 52 (the position where the sheet member P is received from the process liquid drying drum 46). The press roller 54 is configured from a rubber roller, and is disposed so as to press the peripheral face of the image recording drum 52. The sheet member P accordingly makes close contact with the peripheral face of the image recording drum 52 due to passing through the nip portion between the press roller 54 and the image recording drum 52.

The recording heads 56 are configured as full line heads corresponding to the sheet member width and disposed at a fixed separations on the conveying direction downstream side of the press roller 54. A nozzle face (not shown in the drawings) formed with nozzles for jetting liquid droplets is provided to each of the recording heads 56 so as to face towards the peripheral face of the image recording drum 52.

A water-based UV ink is employed as the ink jetted from each of the recording heads 56. The water-based UV inks can be cured by irradiation with ultraviolet (UV) after droplet dotting.

Each of the ink compositions of the present exemplary embodiment contains a pigment, and may be formulated containing a dispersant, a surfactant and/or other such components as required. The ink compositions contain at least one type of pigment as a colorant component. There are no particular limitations to such pigments and pigments may be selected according to the application. The pigments may, for example, be organic pigments or inorganic pigments. The pigments employed are preferably pigments substantially insoluble in water, or difficult to dissolve in water, from the perspective of ink coloration ability. The pigments are also preferably water dispersible pigments with at least part of the surface of the pigment covered by a polymer dispersant.

The ink compositions of the present exemplary embodiment may contain one or more types of dispersant. Dispersants for the pigments may be a polymer dispersant or a low molecular weight surfactant dispersant. Such a polymer dispersant may be a water soluble dispersant or a water insoluble dispersant.

The weight-average molecular weight of such a polymer dispersant is preferably 3000 to 100,000, more preferably 5000 to 50,000, even more preferably 5000 to 40,000, and most preferably 10,000 to 40,000.

The acid value of the polymer dispersant is preferably 100 KOHmg/g or lower from the perspective of good aggregation ability on contact with the process liquid. The acid value is more preferably 25 to 100 KOHmg/g, even more preferably 25 to 80 KOHmg/g and most preferably 30 to 65 KOHmg/g. Good stability of self-dispersibility is achieved when the acid value of the polymer dispersant is 25 or above.

From the perspectives of self-dispersibility and speed of aggregation when the process liquid makes contact, the polymer dispersant preferably contains a polymer with a carboxyl group, and more preferably includes a polymer with a carboxyl group and an acid value of 25 to 80 KOHmg/g.

The present exemplary embodiment preferably contains a pigment and a dispersant from the perspectives of light-fastness and quality of the images, more preferably includes an organic pigment and a polymer dispersant, and most preferably includes a polymer dispersant containing an organic pigment and a polymer dispersant containing a carboxyl group. From the perspective of aggregation ability the pigment is preferably covered by a polymer dispersant containing a carboxyl group and is preferably insoluble in water. From the perspective of aggregation ability the acid value of self-dispersing polymer particles, described later, is preferably smaller than the acid value of the polymer dispersant.

The average particle size of the pigment is preferably 10 to 200 nm, more preferably 10 to 150 nm, and even more preferably 10 to 100 nm. Good color reproducibility is achieved and good droplet dotting characteristics are achieved when droplets are dotted using an inkjet method when the average particle size is 200 nm or less, and there is good light-fastness when the average particle size is 100 nm or less. There are no particular limitations to the size distribution of particles of colorant, and both wide range of particle size distributions and particle size distributions with monodispersed may be employed. Configuration may also be made using a mixture of two or more colorants having particle size distributions with mono-distribution characteristics.

The average particle size and the particle size distribution of pigment particles may be determined by measuring the volume average particle size with a dynamic light scattering method using a Nanotrack UPA-EX150 particle size analyzer (manufactured by Nikkiso Co., Ltd.).

The pigment may employ a single type of pigment on its own, or a combination of two or more types may be employed. The amount of pigment contained in the ink compositions is preferably from 1 to 25 percent by weight of the ink composition from the perspective of image density, more preferably 2 to 20 percent by weight thereof, even more preferably 5 to 20 percent by weight, and most preferably 5 to 15 percent by weight.

The ink compositions of the present exemplary embodiment may be configured to contain one or more types of polymer particle. The polymer particles have the function of solidifying the ink composition by making the dispersion unstable when the polymer particles make contact with the process liquid, described later, or the region where the process liquid has been dried, thereby aggregating and making the ink more viscous. The polymer particles can accordingly enhance the adhesiveness of the ink compositions to the recording medium and can also enhance resistance to rubbing of the images.

Polymer particles are employed having an anionic surface charge so as to react with the aggregating agent, and widely known latexes are employed in a range that obtains both sufficient reaction ability and jetting stability. However polymer particles with self-dispersing properties are particularly preferably employed.

The ink compositions of the present exemplary embodiment preferably include as polymer particles at least one type of self-dispersing polymer particles. Such self-dispersing polymer particles have the function of solidifying the ink composition by making the dispersion unstable when the self-dispersing polymer particles make contact with the process liquid, described later, or the region where the process liquid has been dried, thereby aggregating and making the ink more viscous. The self-dispersing polymer particles can accordingly enhance the adhesiveness of the ink compositions to the recording medium and can also enhance resistance to rubbing of the images. The self-dispersing polymer particles are preferably resin particles from the perspectives of jetting stability and liquid stability (in particular dispersion stability) of a pigment containing system.

Such self-dispersing polymer particles are water insoluble polymers that obtain a dispersed state in an aqueous medium by functional groups (in particular acidic groups or salts thereof) on the polymer itself under conditions in which there is no other surfactant present, and means polymer particles insoluble in water not containing free emulsifying agent.

The acid value of self-dispersing polymer in the present exemplary embodiment is preferably 50 KOHmg/g or lower from the perspective of giving good aggregation ability when contact is made with the process liquid. The acid value thereof is more preferably 25 to 50 KOHmg/g, and even more preferably from 30 to 50 KOHmg/g. Good stability self-dispersal is achieved when the acid value of the self-dispersing polymer is 25 or above

The particles of self-dispersing polymer of the present exemplary embodiment preferably include a polymer with a carboxyl group from the perspectives of self-dispersing ability and aggregation speed when contact is made with the process liquid, more preferably include a polymer that has a carboxyl group and also has an acid value of 25 to 50 KOHmg/g, and are even more preferably the particles include a polymer with a carboxyl group and have an acid value of from 30 to 50 KOHmg/g.

The weight-average molecular weight of a water insoluble polymer forming the particles of the self-dispersing polymer is preferably 3000 to 200,000, is more preferably 5000 to 150,000, and is even more preferably 10,000 to 100,000. The amount of water soluble components can be efficiently suppressed when the weight-average molecular weight is 3000 or more. The self-dispersing stability can be raised when the weight-average molecular weight is 200,000 or lower.

The weight-average molecular weight is measured by gel permeation chromatography (GPC). GPC uses HLC-8220GPC (manufactured by Tosoh Corporation) employing three columns of TSKgeL Super HZM-H, TSKgeL Super HZ4000, and TSKgeL Super HZ2000 (manufactured by Tosoh Corporation with dimensions of 4.6 mm ID×15 cm) and uses THF (tetrahydrofuran) as the eluting solution. The measurement conditions are a sample concentration of 0.35/minute, a flow rate of 0.35 mL/minute, sample injection amount 10 μL, and a measurement temperature of 40° C. An IR detector is used for the measurement.

Standard curves are also obtained from eight samples, standard sample TSK standard polystyrenes F-40, F-20, F-4, F-1, A-5000, A-2500, A-1000 (manufactured by Tosoh Corporation) and n-propylbenzene.

The volume-average particle size of the self-dispersing polymer particles is preferably in the range from 10 nm to 400 nm, more preferably in the range from 10 nm to 200 nm, and still more preferably in the range from 10 nm to 100 nm. The suitability for manufacture is enhanced when the volume-average particle size is 10 nm or greater and storage stability is enhanced when the volume-average particle size is 1 μm or less.

The average particle size and the particle size distribution of the self-dispersing polymer particles are derived from measuring volume-average particle size using dynamic light scattering with a NANOTRAC UPA EX150 particle size distribution measuring instrument (manufactured by Nikkiso Co., Ltd).

One type of the self-dispersing polymer particles may be used alone or a mixture of two or more types of self-dispersing polymer particles may be employed. The content of the self-dispersing polymer particles in the ink composition is preferably from 1 to 30 percent by weight with respect to the ink composition from such perspectives as aggregation speed and glossiness of images, and more preferably from 5 to 15 percent by weight.

The content ratio of pigments to self-dispersing polymer particles in the ink compositions (for example water insoluble pigment particles/ self-dispersing polymer particles) is preferably in the range of from 1/0.5 to 1/10 from the perspective of rubbing resistance of images, and more preferably in the range of from 1/1 to 1/4.

The ink composition of the present exemplary embodiment may include one or more type of water-soluble polymerizable compound that is polymerizable with actinic radiation energy. The polymerizable compound is preferably a nonionic or cationic polymerizable compound from the perspective of not interfering with the aggregating agent's reaction with the pigment and the polymer particles. Reference to water soluble means a compound that can dissolve to a specific concentration or greater in water, or a compound that can dissolve (preferably uniformly) in a water-based ink. The compound may be a compound that dissolves (preferably uniformly) in ink with raised solubility due to addition of a water miscible organic solvent. More specifically, the solubility in water is preferably 10 percent by weight or greater, and more preferably 15 percent by weight of greater.

A nonionic or cationic polymerizable compound is preferably employed as the polymerizable compound from the perspective of not interfering with the aggregating agent's reaction with the pigment and the polymer particles, and a polymerizable compound with a solubility in water of 10 percent by weight or greater (and more preferably 15 percent by weight or greater) is preferably employed.

The polymerizable compound of the present exemplary embodiment is preferably a poly-functional group monomer, and more preferably a two to six functional group monomer, from the perspective of achieving high rubbing resistance. The polymerizable compound is preferably a two to four functional group monomer from the perspectives of achieving both solubility and rubbing resistance. A single type of the polymerizable compound may be included alone or a combination of two or more types of the polymerizable compound may be employed.

The contained amount of the polymerizable compound in the ink compositions is preferably 30 to 300 percent by weight with respect to the total solid components of the pigment(s) and the self-dispersing polymer particles, and more preferably 50 to 200 percent by weight. Excellent rubbing resistance of images is achieved when the contained amount of the polymerizable compound is 30 percent by weight or greater, and a contained amount of 300 percent by weight or less is beneficial from the pile height perspective.

At least one of the ink composition and/or the process liquid also includes an initiator for initiating polymerization of the actinic radiation energy polymerizable compound.

The ink composition of the present exemplary embodiment may be an ink composition containing one or more initiator, for initiating polymerization of the actinic radiation energy polymerizable compound, and the initiator(s) may also be contained in the process liquid or may not be contained in the process liquid. A single type of photo-polymerization initiator may be employed alone or a mixture of two or more types of photo-polymerization initiator may be employed, and a sensitizer may also be employed in combination therewith.

The initiator may contain a suitably selected compound that achieves initiation of a polymerization reaction with actinic radiation energy. For example an initiator (for example a photopolymerization initiator) may be employed that generates an active species (such as a radical, acid or salt) on irradiation with radiation, light or an electron beam.

When an initiator is contained the initiator is preferably contained in the ink composition at 1 to 40 percent by weight with respect to the polymerizable compound, and more preferably at 5 to 30 percent by weight. The rubbing resistance is enhanced when the contained amount of the initiator is 1 percent by weight or greater and such a contained amount is also beneficial for high speed recording. It is beneficial from the perspective of jetting stability for the contained amount of the initiator to be 40 percent by weight or less.

One or more types of water miscible organic solvent may be contained in the ink compositions of the present exemplary embodiment. The water miscible organic solvent can achieve the advantageous effects of drying inhibition, wetting and/or penetration promotion. Preferably a water miscible organic solvent is employed as a drying inhibitor to prevent ink from adhering and drying at the ink jetting apertures of the jetting nozzles and prevent aggregated bodies forming that block the apertures, and a water miscible organic solvent with lower vaporization pressure than water is preferably employed as a drying inhibitor and wetting agent. The water miscible organic solvent may also be employed as a penetration promoter to raise the ink penetration properties to paper.

A water miscible organic solvent having a lower vaporization pressure than water is preferably employed as a drying inhibitor. A single type of drying inhibitor may be employed on its own or a combination of two or more types may be employed. The amount of the drying inhibitor contained in the ink is preferably in the range of 10 to 50 percent by weight.

A penetration promoter is appropriately employed in order to give good penetration of the ink composition into the recording medium (such as printing paper). A single type of penetration promoter may be employed alone or a combination of two or more types may be employed. The amount of the penetration promoter contained in the ink composition is preferably in the range of 5 to 30 percent by weight. The penetration promoter is preferably employed at an amount within a range that does not cause image bleeding or print-through.

The ink composition contains water, however there is no particular limitation to the amount of water contained. A preferable amount of water contained is 10 to 99 percent by weight, with 30 to 80 percent by weight being more preferable and 50 to 70 percent by weight being even more preferable.

The ink composition of the present exemplary embodiment may also be configured with other additives other than the components described above. Examples of such other additives include known additives such as a drying inhibitor (wetting agent), an anti-fading agent, an emulsion stabilizer, a penetration promoter, an ultraviolet absorber, an antiseptic, a fungicide, a pH regulator, a surface tension regulator, a defoaming agent, a viscosity regulator, a dispersant, a dispersion stabilizer, a rust preventing agent and/or a chelating agent

The inline sensor 58 is disposed at a fixed separation on the conveying direction downstream side of the recording heads 56. The inline sensor 58 reads image data formed on the sheet member P by each of the recording heads 56. A contact prevention plate 59 is disposed at the conveying direction downstream side of the inline sensor 58 to prevent the sheet member P from making contact with the inline sensor 58. The contact prevention plate 59 is configured so as to prevent the sheet member P from making contact with the inline sensor 58 when lifting of the sheet member P occurs due for example to poor conveying.

The mist filter 60 is disposed between the recording heads 56 and the inline sensor 58 so as to suck in air at the periphery of the image recording drum 52 and capture any ink mist. The ink mist is thereby suppressed from penetrating to the inline sensor 58, so as to thereby prevent read problems from arising.

The drum cooling unit 62 is provided facing a portion of the lower peripheral face of the image recording drum 52 and is configured mainly including an air conditioner (not shown in the drawings) and a duct 62A to blow the cooled air fed from the air conditioner onto the peripheral face of the image recording drum 52.

Ink Drying Section

The ink drying section 20 is configured to mainly include: a chain gripper 64 serving as an example of a conveying member for conveying the sheet member P on which images have been formed; suction-attachment plates 72 for applying tension to the sheet member P being conveyed by the chain gripper 64; and an ink drying unit 68 for drying the sheet member P being conveyed by the chain gripper 64.

The chain gripper 64 is equipped with chain bodies 64A each configured with: a first sprocket 63A disposed in the vicinity of the image recording drum 52; a second sprocket 63B rotatably provided to the paper discharge section 24; an endless chain 63C entrained around the first sprocket 63A and the second sprocket 63B; and plural chain guides (not shown in the drawings) for guiding travel of the endless chain 63C. The first sprocket 63A is provided with a drive source (not shown in the drawings) for rotating the first sprocket 63A.

Two of the chain bodies 64A are provided at a separation from each other along the sheet member P width direction. Plural individual grippers 64B serving as examples of retaining members are provided spanning between the pair of chain bodies 64A to retain the leading edge portions of the sheet member P being conveyed.

In other words the chain gripper 64 is configured including the pair of chain bodies 64A and the plural individual grippers 64B.

The chain guides are disposed at specific positions so as to guide the travel of each of the endless chains 63C along a specific path. In the image forming apparatus 10 of the present exemplary embodiment the second sprocket 63B is disposed in a position higher than the first sprocket 63A. The endless chain 63C is therefore formed with a travel path that is inclined at an intermediate portion thereof. Specifically the path of the endless chain 63C is configured with a first horizontal conveying path 70A at similar height to the first sprocket 63A, an inclined conveying path 70B, and a second horizontal conveying path 70C at similar height to the second sprocket 63B. Chain guides are accordingly provided at the intersection points of each of these paths where the progression direction changes.

The suction-attachment plates 72 are disposed along the conveying path along which the sheet members P are conveyed by the chain grippers 64. More specifically the suction-attachment plates 72 are disposed along the endless chain 63C at the first horizontal conveying path 70A and the inclined conveying path 70B traveling sections.

Fans 82 are provided inside each of the suction-attachment plates 72 so as to generate suction-attachment force to suction-attach the back face of each of the sheet members P to a suction-attachment surface 72A of the suction-attachment plate 72 (the face facing towards the chain gripper 64 side).

Each of the sheet members P retained at leading edge portions by the chain gripper 64 is thereby conveyed while sliding along the suction-attachment surface 72A of the suction-attachment plate 72, such that back-tension is induced in the sheet member P.

The ink drying unit 68 is disposed on the opposite side of the conveyed sheet member P to the side of the suction-attachment plate 72 disposed on the first horizontal conveying path 70A. The ink drying unit 68 is equipped with plural individual infrared heaters 78 for blowing hot air against the front face of the conveyed sheet member P so as to heat and dry the sheet member P.

Details regarding the configuration of the ink drying section 20 are described later.

UV Irradiation Section

The UV irradiation section 22 is equipped with a UV irradiation unit 74, an example being an ultraviolet lamp, for irradiating ultraviolet radiation onto the sheet member P conveyed by the chain gripper 64. The UV irradiation unit 74 thereby irradiates ultraviolet radiation (UV) onto images formed on the sheet member P, so as to fix the images onto the sheet member P.

Paper Discharge Section

The paper discharge section 24 is equipped with a paper discharge plate 76 for accumulating together the UV irradiated sheet members P released from the grippers 64B, stacked one on top of each other. The paper discharge plate 76 is equipped with a raising and lowering device (not shown in the drawings) that always positions the uppermost sheet member P stacked on the paper discharge plate 76 at a constant height. The paper discharge section 24 thereby accumulates the sheet members P that have been subjected to a cycle of image recording processing by stacking the sheet members P on the paper discharge plate 76.

Due to the configuration described above, sheet members P stacked on the paper feed plate 30 in the paper feeder 12, for forming images on the front face of the sheet members P, are picked up in sequence one sheet at a time by the sucker device 32 and fed into the paper feed rollers 34. Each of the sheet members P fed into the paper feed rollers 34 is then fed out towards the conveyor belt 36 and placed on the conveyor belt 36.

Each of the sheet members P mounted on the conveyor belt 36 is conveyed by the rotating conveyor belt 36. In the conveying process the sheet member P is pressed against the conveying face of the conveyor belt 36 by the retainers 36B so as to correct undulations in the sheet member P. The leading edge portions of the sheet member P conveyed by the conveyor belt 36 make contact with the front stop 38, thereby correcting any skewing. The sheet member P is then passed across to the paper feed drum 40. The sheet member P is then conveyed towards the process liquid application section 14 by the paper feed drum 40.

In the process liquid application section 14 the sheet member P that has been passed across from the paper feed drum 40 is received by the process liquid application drum 42. The process liquid application drum 42 wraps the sheet member P onto the peripheral face of the process liquid application drum 42 and conveys the sheet member P by rotating with the leading edge portions of the sheet member P retained by grippers 42A. The application roller 44A is pressed against the front face of the sheet member P during the conveying process, and the front face of the sheet member P is applied with process liquid (process liquid application process).

In the process liquid drying section 16 the sheet member P that has been passed across from the process liquid application drum 42 is received by the process liquid drying drum 46. The process liquid drying drum 46 conveys the sheet member P by rotating with the leading edge portions of the sheet member P retained by grippers 46A. When this is performed the process liquid drying drum 46 conveys the sheet member P with the front face (the process liquid applied face) facing towards the inside.

During to the process of being conveyed by the process liquid drying drum 46, hot air from the process liquid drying units 50 disposed inside the process liquid drying drum 46 is blown against the sheet member P and the sheet member P is dried (process liquid drying process).

In the image recording section 18 the sheet member P that has been passed across from the process liquid drying drum 46 is received by the image recording drum 52. The image recording drum 52 conveys the sheet member P by rotating with the leading edge portions of the sheet member P retained by grippers 52A. The sheet member P received by the image recording drum 52 is made to make close contact with the peripheral face of the image recording drum 52 by passing through between the image recording drum 52 and the press roller 54. At the same time a suction is applied through suction holes in the image recording drum 52, such that sheet member P is suction-attached to the outer peripheral face of the image recording drum 52.

The sheet member P is conveyed in this state so as to pass through respective positions facing towards each color of the recording heads 56. Liquid droplets (ink) from each color recording head 56 are dotted as droplets onto the front face of the passing sheet member P so as to form a colored image on the front face (image forming process).

The sheet member P formed with images of each color by the recording heads 56 then passes through a position facing towards the inline sensor 58. Image data formed on the front face of the sheet member P is read as the sheet member P passes the inline sensor 58. Such image data reading is performed as required in order to check for such problems as poor jetting in the read images. Abnormalities such as poor jetting can accordingly be detected immediately, thereby enabling rapid countermeasures to be performed.

In the ink drying section 20 the sheet member P that has been passed across from the image recording drum 52 is received by the chain gripper 64. The chain gripper 64 conveys the sheet member P along the suction-attachment plate 72 with leading edge portions of the sheet member P retained by the grippers 64B.

The sheet member P that has been passed across to the chain gripper 64 is conveyed along the first horizontal conveying path 70A. During the process of conveying along the first horizontal conveying path 70A the sheet member P is heated and dried by the infrared heaters 78 (heating and drying process).

In the UV irradiation section 22 ultraviolet radiation from the UV irradiation unit 74 is irradiated onto the front face of the sheet member P being conveyed along the inclined conveying path 70B by the chain gripper 64. UV irradiation processing is thereby performed on the image formed on the sheet member P so as to fix the image onto the sheet member P (light illumination process).

In the paper discharge section 24 the sheet members P that have been UV irradiated and released from the grippers 64B are stacked on the paper discharge plate 76 and accumulated. The sheet members P that have been subjected to one cycle of image recording processing are thereby collected together on the paper discharge plate 76, stacked one on top of each other.

Relevant Configuration Portions

Detailed explanation follows regarding such aspects as configuration of the ink drying section 20.

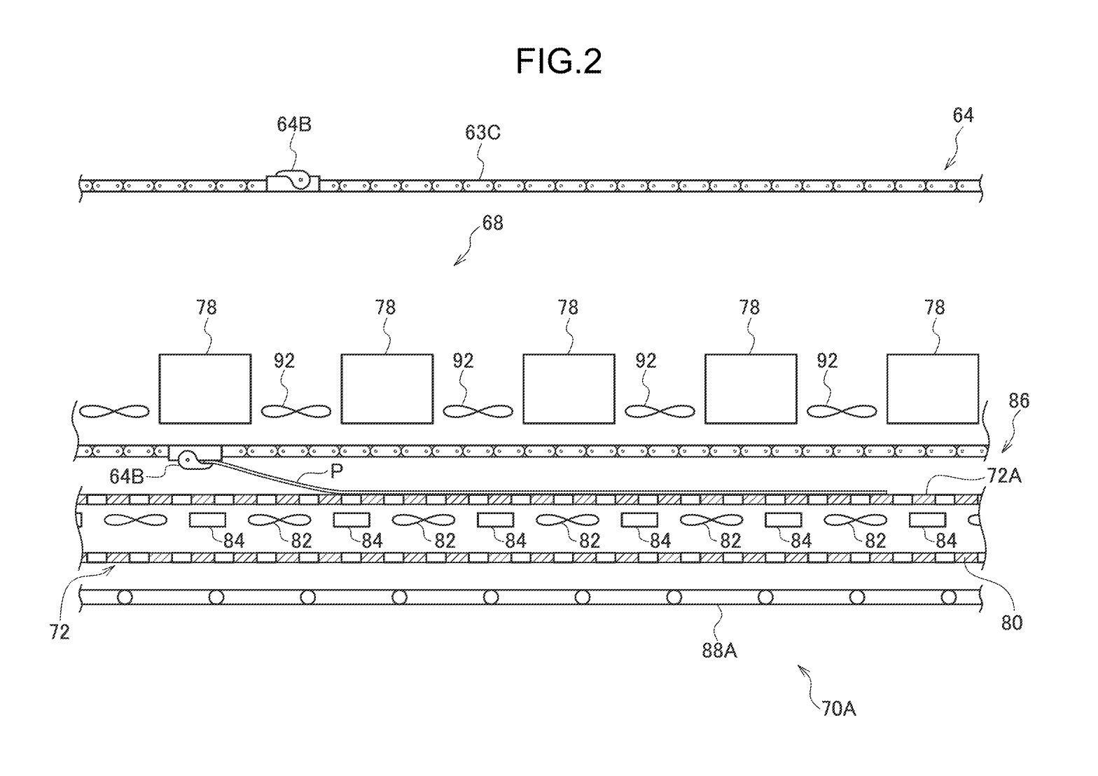

As shown in FIG. 1 and FIG. 2, the suction-attachment plate 72 is equipped with a box shaped casing 80 formed with multiple suction holes and discharge holes in the outer peripheral face of the casing 80, and with the plural individual fans 82 that generate suction-attachment force to the suction-attachment surface 72A disposed in the casing 80. In the present exemplary embodiment the vertical separation is 25 mm between the suction-attachment surface 72A and the grippers 64B that retain the leading end portions of the sheet member P.

Plural individual heaters 84 are also installed in the suction-attachment plate 72 provided in the first horizontal conveying path 70A for heating the suction-attachment surface 72A of the suction-attachment plate 72. The heaters 84 are disposed along the suction-attachment surface 72A between a given fan 82 and another fan 82.

A cooling device 88 is also provided as an example of a cooling member for cooling the suction-attachment surface 72A of the suction-attachment plate 72 on the opposite side of the suction-attachment plate 72 to the chain gripper 64 side.

The cooling device 88 is equipped with a cooling pipe 88A through which cooling water flows, a heat exchanger (not shown in the drawings) for cooling the cooling water flowing in the cooling pipe 88A, and a pump 88B for circulating the cooling water in the cooling pipe 88A.

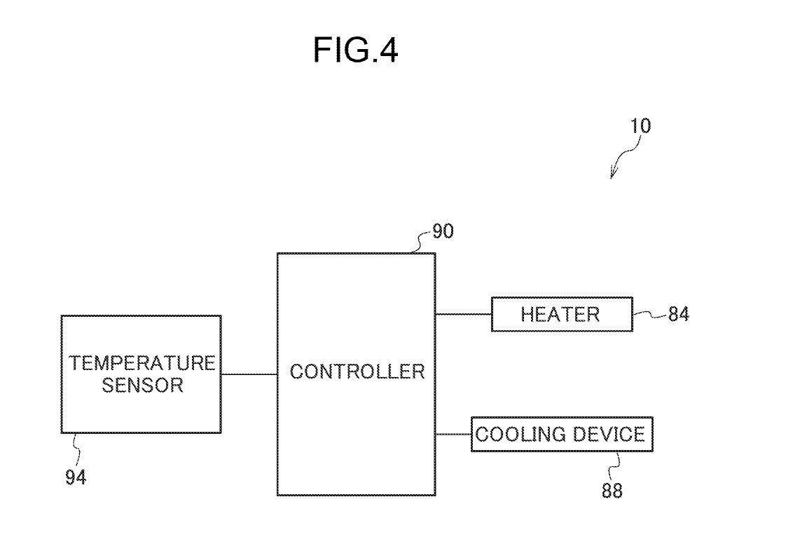

A temperature sensor 94 serving as an example of a measuring member is also provided for measuring the temperature of the suction-attachment surface 72A of the suction-attachment plate 72. As shown in FIG. 4, a controller 90 is provided to the image forming apparatus 10 for controlling at least one of the heaters 84 and/or the cooling device 88 based on a detection result of the temperature sensor 94.

In such a configuration, the controller 90 controls at least one of the heaters 84 and/or the cooling device 88 such that when the sheet member P is suction-attached to the suction-attachment surface 72A the temperature of the suction-attachment surface 72A is from 30° C. to 70° C.

As shown in FIG. 2, plural individual infrared heaters 78 are provided as described above in a row along the sheet member conveying direction on the opposite side of the conveyed sheet member P to the suction-attachment plate 72 side. Fans 92 are also provided as examples of air moving members between one of the infrared heaters 78 and another of the infrared heaters 78, for blowing air against the front face of the sheet member P being conveyed by the chain gripper 64.

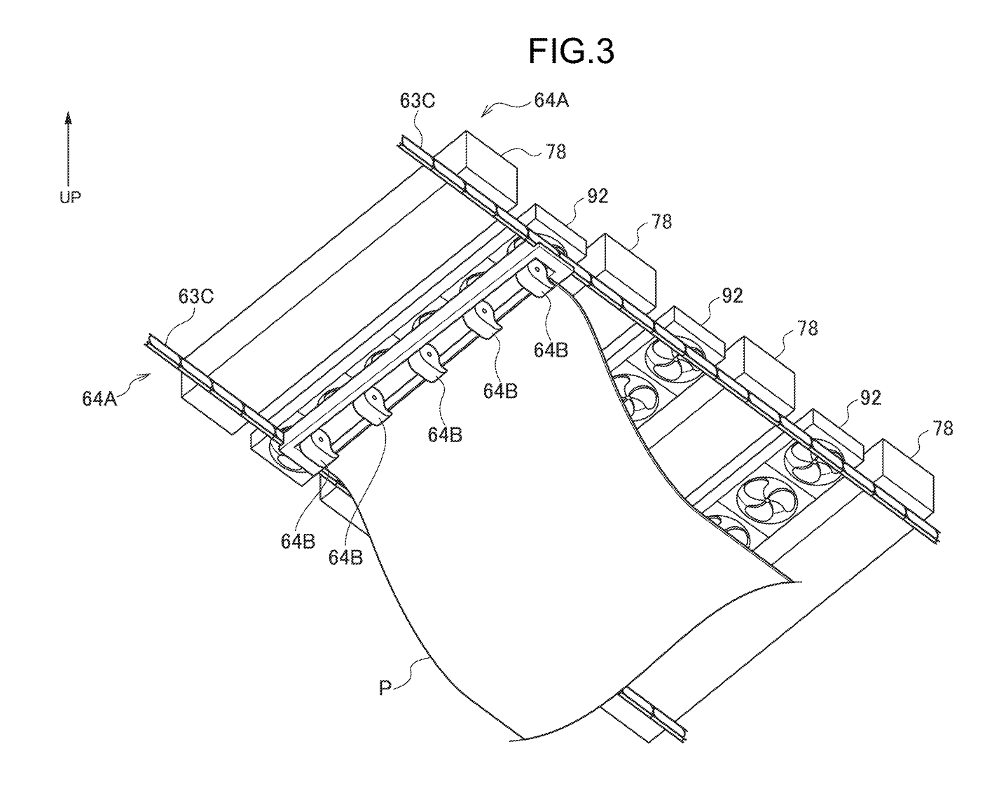

Specifically, as shown in FIG. 3, the fans 92 are provided in plural individual rows along the sheet member P width direction, and, as shown in FIG. 2, the fans 92 and the infrared heaters 78 are disposed alternately along the sheet member P conveying direction.

The output of each of the infrared heaters 78 is determined such that the front face of the conveyed sheet member P is imparted with heat energy of from 1.0 J/cm² to 5.0 J/cm². Operation and Advantageous Effects of Relevant Configuration Portions Explanation follows regarding the operation and advantageous effects of relevant configuration portions.

As shown in FIG. 1 and FIG. 2, in the ink drying section 20 the sheet member P that has been passed across from the image recording drum 52 is received by the chain gripper 64. The chain gripper 64 retains the leading end portions of the sheet member P with the grippers 64B, and the sheet member P is conveyed along the suction-attachment plate 72.

More specifically, the leading end portions of the sheet member P are in a retained state by the grippers 64B, and the sheet member P is conveyed with the leading end portions of the sheet member P being pulled towards the conveying direction downstream side. The back face of the sheet member P is suction-attached to the suction-attachment surface 72A of the suction-attachment plate 72 placed at a temperature of from 30° C. to 70° C. under control from the controller 90 (see FIG. 4).

The sheet member P is accordingly conveyed while sliding along the suction-attachment surface 72A of the suction-attachment plate 72 with the leading end portions of the sheet member P pulled towards the conveying direction downstream side, such that the sheet member P is imparted with a back-tension.

The infrared heaters 78 heat and dry the sheet member P such that the front face of the conveyed sheet member P is imparted with heat energy of from 1.0 J/cm² to 5.0 J/cm².

The leading end portions of the sheet member P are retained by the grippers 64B and separated from the suction-attachment surface 72A of the suction-attachment plate 72, however the trailing end side of the sheet member P (locations excluding the leading end side) is in close contact with the suction-attachment surface 72A of the suction-attachment plate 72.

The relationship to the suction-attachment plate 72 is accordingly different between the leading end side and the trailing end side of the sheet member P. It is thought that irregularities in drying of an image formed on the sheet member P therefore occur, with this leading to a difference in the film strength of an image formed to the sheet member P between the leading end side and at the trailing end side. It is also thought to lead to glossiness difference arising between the leading end side and the trailing end side of the sheet member P and to the generation of paper creasing.

Evaluation Device

Evaluation is therefore performed of film strength, glossiness difference and creasing.

Evaluation Device and Evaluation Members

Evaluation is performed employing the above image forming apparatus while varying the irradiation intensity of the infrared heaters 78 and the temperature of the suction-attachment surface 72A of the suction-attachment plate 72.

The sheet members P employed in evaluation are coated paper, OK TOPCOAT PLUS (trade name) manufactured by Oji Paper Co., Ltd. with a basis weight of 104.7 gsm at a half-cut kiku size (width direction dimension 636 mm, conveying direction dimension 469 mm) with vertical machine direction.

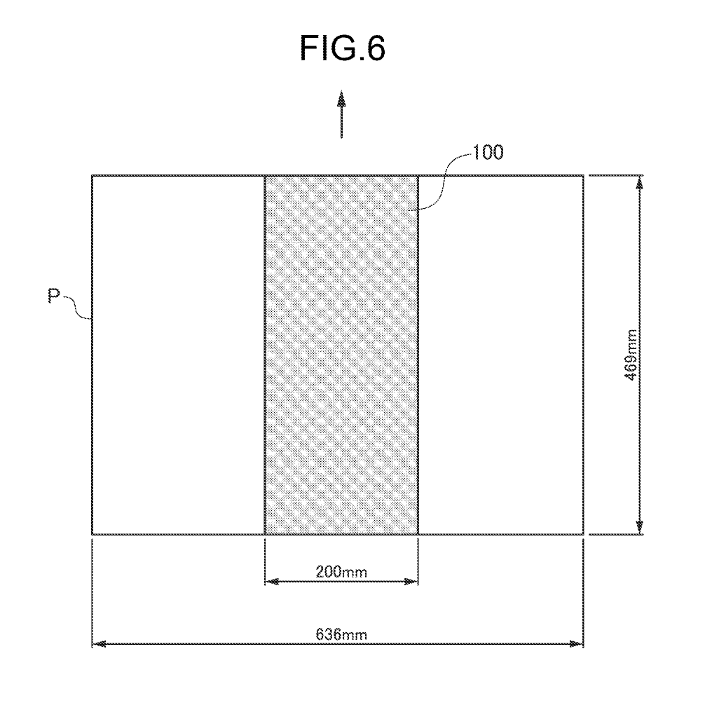

As shown in FIG. 6, a solid print region 100 is formed at the central side of the evaluation sheet member P extending across a width of 200 mm from the leading end portion to the trailing end portion of the sheet member P. The solid print region 100 is formed by dotting droplets of ink (black ink). More specifically, the solid print region 100 is formed by dotting 6 μL droplets of ink at 1200 dpi (ink droplet dotting amount 13.0 g/m²). The solid print region 100 and white margins are combined together in a pattern formed on the sheet member P that readily generates creasing.

The ink formulation is listed below.

Ink Formulation

| | |
|---|---|
| Pigment: | 4 parts by weight |
| Dispersant polymer: | 2 parts by weight |
| Resin emulsion: | 8 parts by weight |
| Water miscible organic solvent | 15 parts by weight |
| Olfine E1010 (manufactured by | 1 part by weight |
| Nisshin Chemical Co., Ltd.): | |
| Ion-exchange water: | Balance |
| Pigment: | Cromophtal Jet Magenta DMQ |
| | (PR-122) manufactured by |
| | Ciba Specialty Chemicals |
| Dispersant polymer: | Benzyl methacrylate/methyl |
| | methacrylate/methacrylic |
| | acid copolymer |
| Mass ratio: | 60/30/10 |
| Resin emulsion: | Methyl methacrylate/ |
| | phenoxyethyl acrylate/ |
| | acrylic acid copolymer |
| Mass ratio: | 66/29/5 |
| Glass transition temperature: | 65° C. |

Evaluation Method 1

Film Strength Evaluation Method and Evaluation Criteria

Measurement Instrument:

TriboStation Heidon Type 32, made by Shinto Scientific Co., Ltd.

Evaluation Conditions: Evaluation 1 hour after printing, at 23° C. and 50% RH

Evaluation Method: 30 mm squares of white paper are adhered to a flat face press-plate, and the adhered white paper is rubbed against the image face with a load of 400 g, a stroke length of 50 mm, and a speed of 100 mm/s. Evaluation is performed at a location 50 mm from the leading edge and at a location 50 mm from the trailing edge of the sheet member. The surface state of the sample is determined by inspection (by the naked eye).

| | | |
|---|---|---|
| AA | no change to surface state | |
| A | slight change in glossiness of | (permissible quality) |
| | surface state | |
| B | change in glossiness on surface | (permissible quality) |
| C | damage due to film rupture | (not permissible quality) |

Glossiness Difference (Glossiness Uniformity) Evaluation Method and Evaluation Criteria 60 degree glossiness is measured with a gloss checker (IG-320, made by Horiba Ltd.) and the difference calculated between the glossiness at the leading end side and the trailing end side of the sheet member.

| | | |
|---|---|---|
| A | glossiness difference less than 4 | (permissible quality) |
| B | glossiness difference 4 or greater | (permissible quality) |
| | but less than 8 | |
| C | glossiness difference 8 or greater | (not permissible quality) |

Paper Creasing Evaluation Method and Evaluation Criteria

Determined by visual inspection of paper with the naked eye.

| | |
|---|---|
| A | no paper creasing |
| B | slight paper creasing within permissible range |
| C | paper creasing present |

Evaluation Results 1

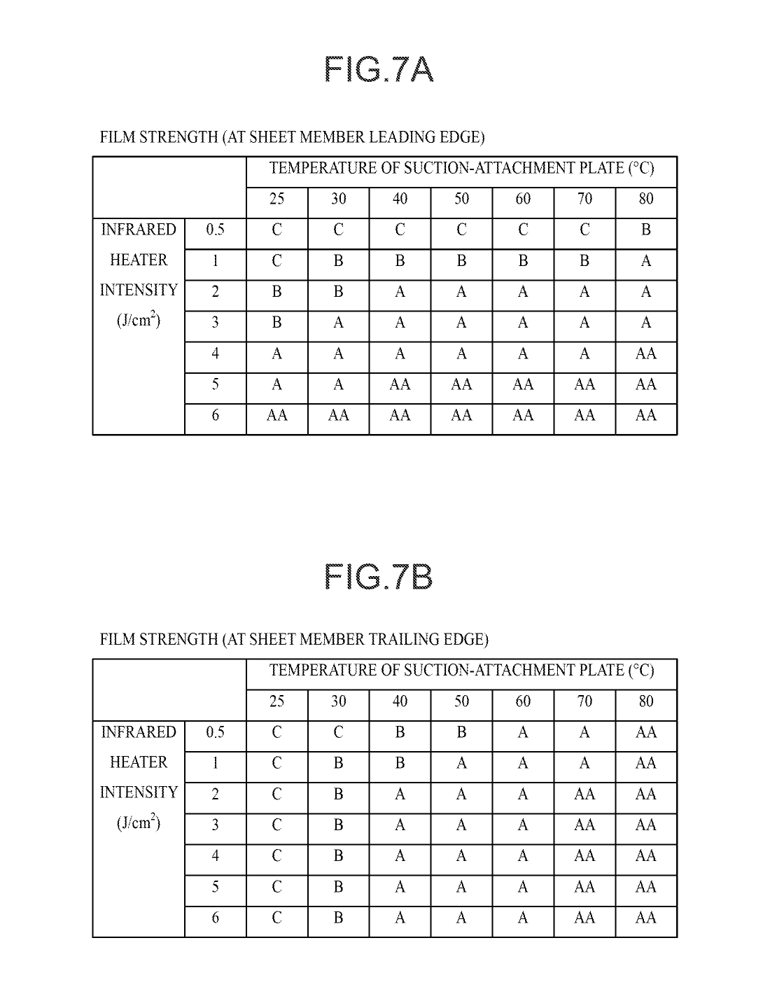

FIG. 7A illustrates evaluation results for film strength evaluation at the leading end side of the sheet member P. FIG. 7B illustrates evaluation results for film strength at the trailing end side of the sheet member P.

As shown in FIG. 7A, the film strength at the sheet member leading end side has a high correlation with the intensity of the infrared heaters 78. This is thought to be due to the leading end side of the sheet member P not being in close contact with the suction-attachment surface 72A of the suction-attachment plate 72. Heat is therefore not readily conducted thereto from the suction-attachment surface 72A, and intensity of heating from the front face side of the sheet member P dominates drying.

However, as shown in FIG. 7B, the film strength at the sheet member trailing end side has a high correlation with the temperature of the suction-attachment plate 72. This is thought to be due to the trailing end side of the sheet member P being in close contact with the suction-attachment surface 72A of the suction-attachment plate 72, and heat conducted from the suction-attachment surface 72A therefore dominating drying.

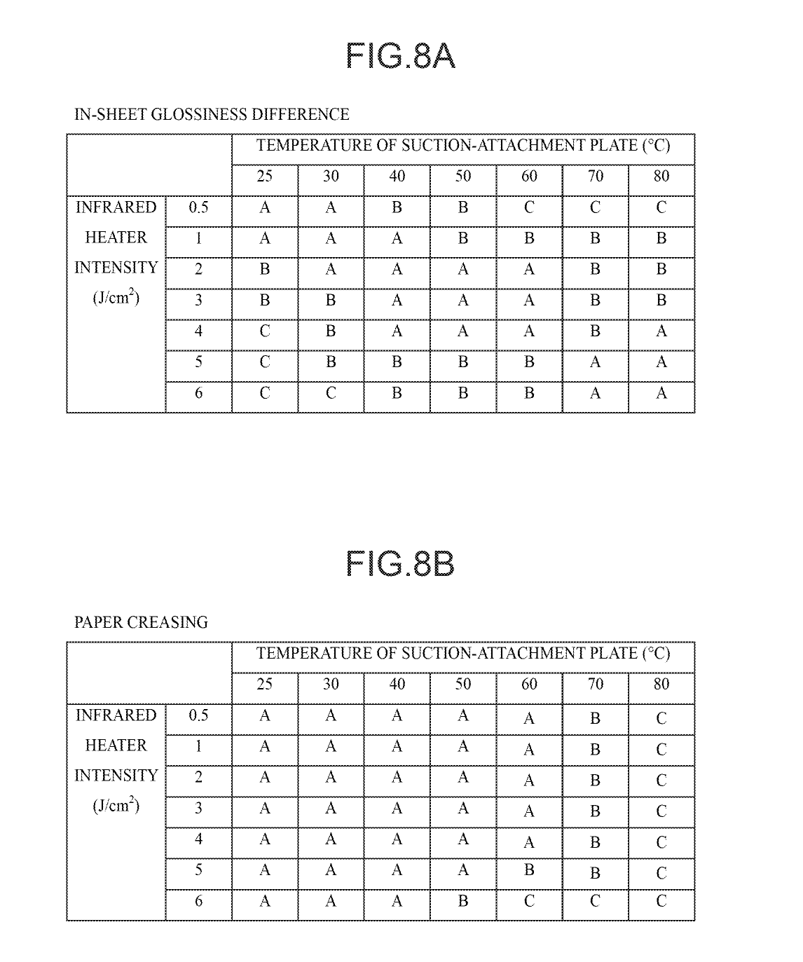

FIG. 8A illustrates evaluation results of glossiness uniformity evaluation (glossiness difference). The glossiness difference has a small difference in glossiness (good performance) in regions at the leading end side and at the trailing end side of the sheet member P where the film strength is at a similar level. It is thought that the surface state of the ink film is made uniform due to there being no unevenness in drying under these conditions.

FIG. 8B illustrates evaluation results of paper creasing evaluation. Paper creasing worsens as the temperature of the suction-attachment surface 72A rises, and is an evaluation of C (not permissible quality) at 80° C. Paper creasing also worsens when the intensity of the infrared heaters 78 is too intense. This is thought to be creasing arising from distortion between the inside of the sheet member P where excessive drying induces shrinkage of the sheet member P, and expanding portions of the sheet member P where ink penetration occurs.

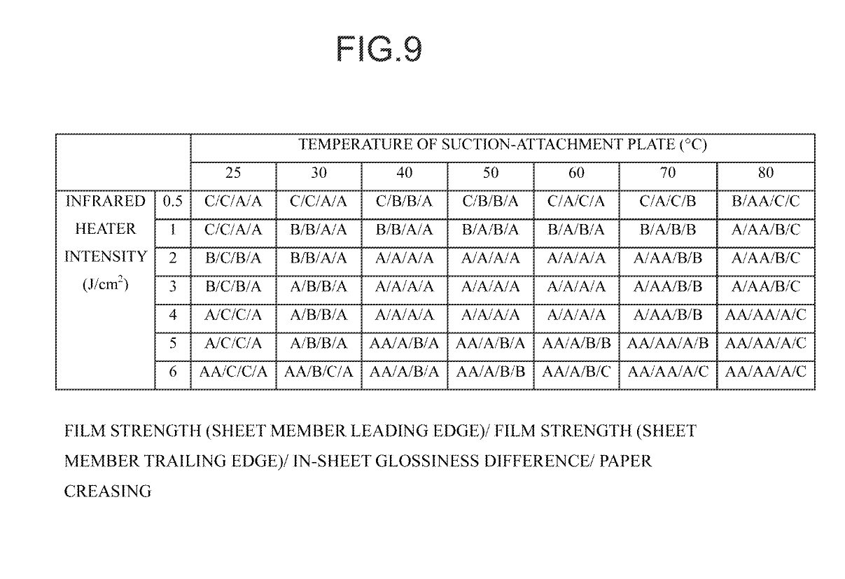

FIG. 9 shows a summary of evaluation results for leading end side film strength evaluation, trailing end side film strength evaluation, glossiness uniformity evaluation, and paper creasing evaluation. It can be seen from looking at the total evaluation results that permissible quality is always achieved under conditions of the temperature of the suction-attachment surface 72A being from 30° C. to 70° C. and the illumination intensity of the infrared heaters 78 being from 1.0 J/cm² to 5.0 J/cm². It can be seen that evaluations of “B” do not occur under conditions of the temperature of the suction-attachment surface 72A being from 40° C. to 60° C. and the illumination intensity of the infrared heaters 78 being from 2.0 J/cm² to 4.0 J/cm², and the quality is always stable (it can be seen that these are more preferable conditions).

Evaluation Method 2

Explanation follows regarding evaluation performed with the addition of application of a process liquid to the previously described evaluation method (Evaluation Method 1). Aspects other than those described in the following are similar to those of the previously described evaluation method (Evaluation Method 1).

| | |
|---|---|
| Process liquid application amount: | 1.5 g/m² |
| Process liquid drying: | No |
| Process liquid formulation | |
| Malonic acid: | 10 parts by weight |
| Diethyleneglycol monobutylether: | 20 parts by weight |
| Olfine E1010 (manufactured by Nisshin | 1 part by weight |
| Chemical Co., Ltd.): | |
| Ion-exchange water: | Balance |

Evaluation Results 2

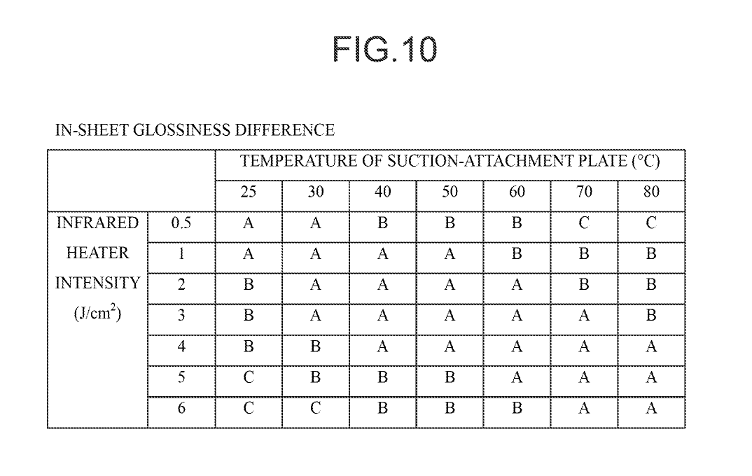

FIG. 10 illustrates evaluation results of glossiness uniformity evaluation (glossiness difference). It can be seen that the glossiness difference (uneven glossiness) is somewhat improved relative to Evaluation Results 1 by application of the process liquid. It is thought that the ink film surface state is stabilized by using the process liquid to enhance the adhesiveness of the ink to the sheet member P.

It can be seen that, similarly to with Evaluation Results 1, permissible quality is always achieved under conditions in which the temperature of the suction-attachment surface 72A is from 30° C. to 70° C. and the illumination intensity of the infrared heaters 78 is from 1.0 J/cm² to 5.0 J/cm².

Evaluation Method 3

Explanation follows regarding evaluation performed with a process of process liquid drying added to the previously described evaluation method (Evaluation Method 2). Aspects other than those described in the following are similar to those of the previously described evaluation methods (Evaluation Method 1, and Evaluation Method 2).

| | |
|---|---|
| Process liquid application amount: | 1.5 g/m² |
| Process liquid drying: | Yes (blowing with air at 70° C.) |

Evaluation Results 3

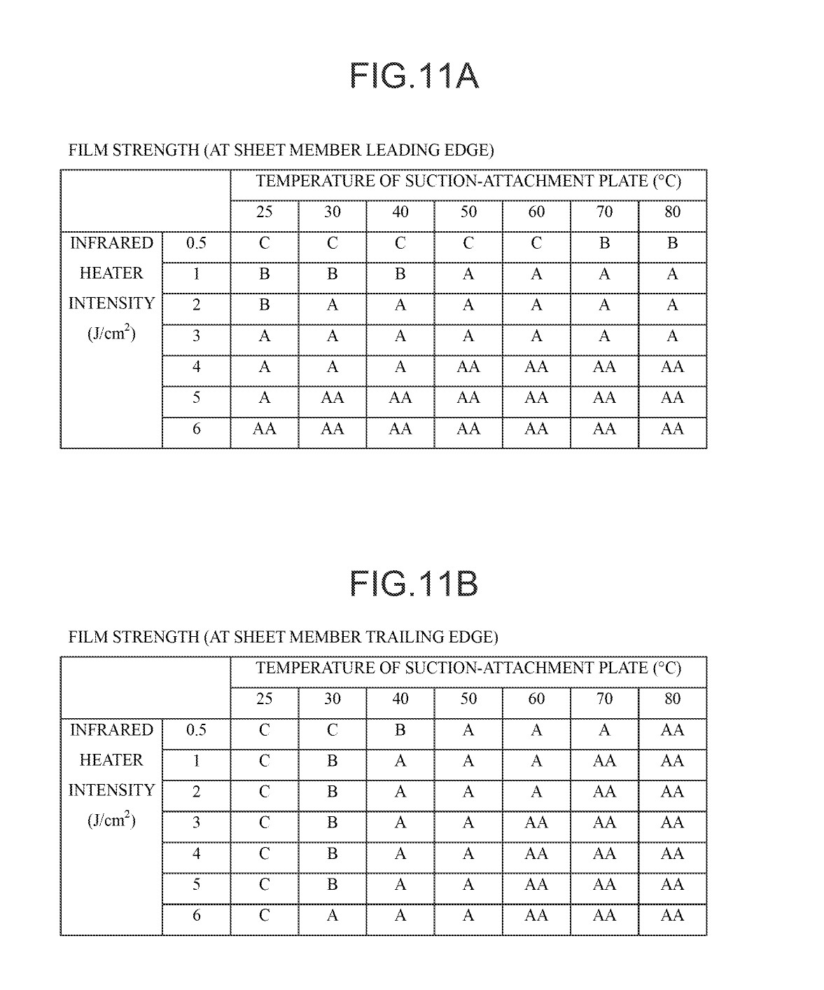

FIG. 11A illustrates evaluation results of film strength evaluation at the leading end side of the sheet member P. FIG. 11B illustrates evaluation results of film strength at the trailing end side of the sheet member P.

It can be seen that the film strength is somewhat improved relative to the Evaluation Results 1 by drying the process liquid prior to image forming (prior to image rendering). It is thought that this effect is caused by the degree of close contact between the ink and the sheet member P being improved by the liquid component of the process liquid on the sheet member front face being removed by drying the process liquid.

It can also be seen that, similarly to in the Evaluation Results 1, permissible quality is always achieved under conditions in which the temperature of the suction-attachment surface 72A is from 30° C. to 70° C. and the illumination intensity of the infrared heaters 78 is from 1.0 J/cm² to 5.0 J/cm².

It can be seen from the above evaluation results that the quality of the film strength of an image formed on the sheet member P can be made a permissible quality from the leading end side to the trailing end side of the sheet member P by making the temperature of the suction-attachment surface 72A from 30° C. to 70° C. and making the heat energy applied to the front face of the sheet member P from 1.0 J/cm² to 5.0 J/cm². Namely the quality of film strength of an image formed on the sheet member P can be secured from the leading end side across to the trailing end side of the sheet member P.

The quality of glossiness uniformity can also be made permissible by making the temperature of the suction-attachment surface 72A from 30° C. to 70° C. and making the heat energy applied to the front face of the sheet member P from 1.0 J/cm² to 5.0 J/cm².

The quality of paper creasing can also be made permissible by making the temperature of the suction-attachment surface 72A from 30° C. to 70° C. and making the heat energy applied to the front face of the sheet member P from 1.0 J/cm² to 5.0 J/cm².

The temperature of the suction-attachment surface 72A can also be easily regulated due to the cooling device 88 cooling the suction-attachment surface 72A.

The temperature of the suction-attachment surface 72A can also be easily regulated due to the heaters 84 heating the suction-attachment surface 72A.

The temperature of the suction-attachment surface 72A can be even more easily regulated due to the controller 90 controlling at least one of the cooling device 88 and/or the heaters 84 based on the measurement results of the temperature sensor 94.

The film strength of images can also be enhanced due to using the UV irradiation unit 74 to irradiate the ultraviolet-curing ink jetted from the recording heads 56 towards the sheet member P.

Heating and drying of the sheet member P by the infrared heaters 78 can also be promoted by the fans 92 blowing air against the front face of the sheet member P conveyed by the chain gripper 64.

The process liquid application unit 44 also applies the sheet member P with the process liquid for enhancing the adhesiveness of the ink (liquid droplets) to the sheet member P. The adhesiveness of the ink (liquid droplets) to the sheet member P can accordingly be enhanced.

The process liquid drying unit 50 also dries the process liquid applied to the sheet member P by the process liquid application unit 44. Adhesiveness of the ink (liquid droplets) to the sheet member P can accordingly be further enhanced.

The present invention has been explained in detail by way of particular exemplary embodiments, however the present invention is not limited by these exemplary embodiments. It will be obvious to a person of ordinary skill in the art that various other exemplary embodiments are possible within the scope of the present invention. For example, whereas the heaters 84 and the cooling device 88 are employed in the exemplary embodiments above to regulate the temperature of the suction-attachment surface 72A, there is no particular need to employ these devices. For example, configuration may be made such that the temperature of the suction-attachment surface 72A is regulated by using heat from the infrared heaters 78.

In the above exemplary embodiments, while not mentioned in particular, ink containing thermoplastic resin particles may be employed as the ink (liquid droplets) jetted from the recording heads 56. In such cases the quality of film strength can be enhanced without employing ultraviolet-curing ink.

In the above exemplary embodiments a back-tension is applied to the sheet member P being heated and dried, however configuration may be made such that the sheet member P is heated and dried without application of a back-tension to the sheet member P.

What is claimed is:

1. An image forming apparatus comprising:
an image forming member that jets liquid droplets onto a recording medium and forms an image on a front face of the recording medium;
a conveying member that retains with a retaining member a leading end portion of the recording medium on which the image has been formed by the image forming member and conveys the recording medium;
a suction-attachment plate that is disposed with a separation from the conveying member, the suction-attachment plate suction-attaching a back face of the recording medium being conveyed by the conveying member while the leading end portion of the recording medium is retained by the retaining member and including a suction-attachment plate with a temperature at a suction-attachment surface of from 30° C. to 70° C. for suction-attaching the recording medium; and
a heating member that is disposed on an opposite side of the conveyed recording medium to the suction-attachment plate side and heats and dries the recording medium such that the front face of the recording medium being conveyed by the conveying member is imparted with heat energy of from 1.0 J/cm² to 5.0 J/cm².

2. The image forming apparatus of claim 1, further comprising a cooling member for cooling the suction-attachment plate provided at an opposite side of the suction-attachment plate to the conveying member side.

3. The image forming apparatus of claim 1, further comprising a heater for heating the suction-attachment plate installed in the suction-attachment plate.

4. The image forming apparatus of claim 1, further comprising:
a measuring member for measuring the temperature of the suction-attachment surface of the suction-attachment plate;
a cooling member for cooling the suction-attachment plate;
a heater for heating the suction-attachment plate; and
a controller that controls the cooling member and/or the heater based on the measurement result of the measuring member such that the temperature of the suction-attachment surface is from 30° C. to 70° C.

5. The image forming apparatus of claim 1, wherein:
the image forming member jets ultraviolet-curing ink towards the recording medium; and
the image forming apparatus further comprises an ultraviolet lamp that illuminates light for curing ultraviolet-curing ink onto the recording medium heated and dried by the heating member.

6. The image forming apparatus of claim 1, wherein the image forming member jets ink containing thermoplastic resin particles towards the recording medium.

7. The image forming apparatus of claim 1, further comprising an air moving member that blows air against the front face of the recording medium being conveyed by the conveying member.

8. The image forming apparatus of any one of claim 1, further comprising a process liquid application member that is provided at a recording medium conveying direction upstream side of the image forming member and that applies to the recording medium a process liquid for enhancing adhesiveness of liquid droplets to the recording medium.

9. The image forming apparatus of claim 8, further comprising a drying member that dries the process liquid that has been applied to the recording medium by the process liquid application member.

10. An image forming method comprising:
an image forming process of jetting liquid droplets onto a recording medium and forming an image on a front face of the recording medium; and
a heating and drying process of making a temperature of a suction-attachment surface for suction-attaching a back face of the recording medium that is being conveyed while a leading end portion of the recording medium is retained be from 30° C. to 70° C., and heating and drying the recording medium such that the front face of the recording medium being conveyed is imparted with heat energy of from 1.0 J/cm² to 5.0 J/cm².

11. The image forming method of claim 10, wherein:
the liquid droplets for forming an image on the recording medium are liquid droplets of ultraviolet-curing ink; and
the image forming method further comprises a light illumination process of illuminating light for curing ultraviolet-curing ink towards the recording medium whose image has been heated and dried in the heating and drying process.

12. The image forming method of claim 10, further comprising, prior to the image forming process, a process liquid application process in which a process liquid is applied to the recording medium for enhancing adhesiveness to the recording medium of the liquid droplets jetted towards the recording medium in the image forming process.

13. The image forming method of claim 12, further comprising a process liquid drying process in which the process liquid applied to the recording medium in the process liquid application process is dried.
